(19) United States
(12) Patent Application Publication
(10) Pub. No.: US 2025/0307879 A1
(43) Pub. Date: Oct. 2, 2025

(54) METHOD FOR INTELLIGENT ADVERTISEMENT DELIVERY AND ELECTRONIC DEVICE

(71) Applicant: Hangzhou Alibaba International Internet Industry Co., Ltd., Hangzhou (CN)

(72) Inventors: Hongtao LIU, Hangzhou (CN); Long FAN, Hangzhou (CN); Yang LI, Hangzhou (CN); Chuan YUE, Hangzhou (CN)

(21) Appl. No.: 19/067,353

(22) Filed: Feb. 28, 2025

(30) Foreign Application Priority Data
Mar. 28, 2024 (CN) 202410369876.7

(51) Int. Cl. G06Q 30/0273; G06Q 30/0251

(52) U.S. Cl. CPC G06Q 30/0275; G06Q 30/0256

(57) ABSTRACT

The embodiments of this application disclose a method for intelligent advertisement delivery and an electronic device. The method includes: determining a set of products designated by at least one first user that require intelligent advertisement delivery; matching product information in the determined set of products with key information associated with a product search request initiated by a second user during a process of responding to the product search request; estimating promotional performance evaluation metrics for a target product that successfully matches the key information and belongs to the set of products; performing intelligent bidding for the target product based on the estimated result, to determine, based on the intelligent bidding result, whether the target product qualifies for promotional display using a target display resource on a search result page, wherein the target display resource is designated to meet a requirement of the advertisement delivery.

### CROSS-REFERENCE TO RELATED APPLICATIONS

This application claims priority to Chinese Patent Application No. 202410369876.7, filed with the China National Intellectual Property Administration on Mar. 28, 2024, and entitled “Method for Intelligent Advertisement Delivery and Electronic Device,” which is incorporated herein by reference in its entirety.

### TECHNICAL FIELD

The present application pertains to the technical field of information delivery, and more specifically, relates to an intelligent advertisement delivery method and electronic device.

### BACKGROUND

In a product information service system, merchant users can not only publish product information within the system but also increase the exposure and traffic of certain products by placing advertisements. The so-called “advertisement” here refers to advertisements delivered through the product information service system. These are paid information transmissions conducted by merchants to promote their products, enabling information exchange between consumers and merchants via the product information service system.

In the product information service system, various types of advertisement delivery methods are typically provided for merchants. These methods generally include two types: SS (Sponsored Search), which are search result advertisements, and SP (Sponsored Product), which are recommendation advertisements.

SS refers to advertisements displayed on search result pages. If a merchant wishes to place SS-type advertisements for one or more products, the core aspect lies in bidding for search keywords that match the product. In this process, the merchant needs to configure keywords for the product and set bids for these keywords. This way, when consumers search for these keywords, the product has a certain probability of appearing in the search results. Additionally, it is possible to set a separate premium for specific positions on the search result page (e.g., the first item, also referred to as the “top slot”). This involves adding a certain premium percentage on top of the original bid, thereby increasing the bidding price for these specific positions. This enhances the probability of the product appearing in such premium positions, ultimately improving the advertisement's effectiveness.

SP refers to advertisements displayed on product recommendation pages. These pages may include the client's homepage, related recommendations on product detail pages, or related recommendations on order pages, among others. If a merchant wishes to place SP-type advertisements for one or more products, they can set bids for these products. This allows the product to have a certain probability of appearing in the recommendation results when products are recommended to consumers. For SP-type advertisements, merchants can also set specific premiums for target audiences. For example, a premium can be applied to a core user group of a specific product, increasing the probability of the product being seen by users within this core group based on the original bid. This, in turn, enhances the effectiveness of the advertisement, among other benefits.

In summary, there can be various types of advertisement delivery methods. During the process of delivering different types of advertisements, bidding is required separately. Specifically, merchants must determine how much they are willing to bid for specific keywords (for SS-type advertisements) or for products (for SP-type advertisements, where the product bid serves as the base price for audience premiums; if the audience premium is 0%, the product's base bid is used for the auction). On this basis, for certain products, if merchants wish to achieve a higher ranking on search result pages, appear in special positions, or target specific user groups in recommendations, they can apply a premium, i.e., an additional amount they are willing to pay. The specific configurations for bidding, premiums, and similar parameters must be determined by the merchants during the advertisement setup process.

However, since there are various types of advertisement delivery methods, each requiring separate configurations for bidding, premiums, and other parameters, the delivery process can become quite complex.

### SUMMARY

The present application provides a method for intelligent advertisement delivery and an electronic device, which can simplify the advertisement delivery process for a first user.

The present application offers the following solution:
an intelligent advertisement delivery method, including:
determining a set of products designated by at least one first user that require intelligent advertisement delivery;
matching product information in the determined set of products with key information associated with a product search request initiated by a second user during a process of responding to the product search request;
estimating promotional performance evaluation metrics for a target product that successfully matches the key information and belongs to the set of products;
performing intelligent bidding for the target product based on an estimated result, to determine, based on an intelligent bidding result, whether the target product qualifies for promotional display using a target display resource on a search result page, wherein the target display resource is designated to meet a requirement of the advertisement delivery.

In some embodiments, the promotional performance evaluation metrics comprise a plurality of types;
performing intelligent bidding for the target product based on the estimated result includes:
determining a current growth stage level of the target product and establishing a growth objective based on the determined current growth stage level;
selecting one specific promotional performance evaluation metric from the plurality of types of promotional performance evaluation metrics based on the growth objective, and performing intelligent bidding for the target product based on the estimated result for a selected promotional performance evaluation metric.

In some embodiments, the promotional performance evaluation metrics include a click-through rate (CTR) metric;
determining the growth objective of the target product based on the current growth stage level includes:
if the current growth stage level is a new product stage, determining the growth objective of the target product as transitioning into a potential product by improving the CTR, wherein intelligent bidding is performed for the target product based on the estimated result for the CTR metric.

In some embodiments, the promotional performance evaluation metrics include a conversion rate metric;
determining the growth objective of the target product based on the current growth stage level includes:
if the current growth stage level is a potential product stage, determining the growth objective of the target product as transitioning into a trending product by improving the conversion rate, wherein intelligent bidding is performed for the target product based on the estimated result for the conversion rate metric; the trending product is defined as a product with a conversion rate exceeding a specified threshold.

In some embodiments, the promotional performance evaluation metrics include a transaction value metric;
determining the growth objective of the target product based on the current growth stage level includes:
if the current growth stage level is a trending product stage where a conversion rate exceeds a specified threshold, determining the growth objective of the target product as increasing the transaction value, wherein intelligent bidding is performed for the target product based on the estimated result for the transaction value metric.

In some embodiments, the method further includes:
obtaining budget information configured by the first user for the intelligent advertisement delivery requirements;
performing intelligent bidding for the target product based on the estimated result includes:
performing intelligent bidding for the target product based on the estimated result and the budget information.

In some embodiments, the method further includes:
upon determining that a target product has qualified for promotional display using a target display resource on the search result page, generating a creative target image for the target product using an image generation model, wherein the creative target image is used as a representative image of the target product and displayed in the corresponding target display resource slot.

In some embodiments, the method further includes:
collecting statistical data on the actual promotional performance of the target product during its promotional display on the search result page based on the intelligent bidding result;
determining an optimization adjustment to a key information matching strategy and/or an intelligent bidding strategy for the target product based on a statistical result.

An intelligent advertisement delivery method, including:
determining a set of products designated by at least one first user that require intelligent advertisement delivery;
matching product information in the determined set of products with a region and/or demographic group associated with a second user during a process of recommending a product to the second user;
estimating promotional performance evaluation metrics for target product that successfully matches the region and/or demographic group and belongs to the set of products;
performing intelligent bidding for the target product based on an estimated result to determine, based on an intelligent bidding result, whether the target product qualifies for promotional display using a target display resource on a product recommendation page, wherein the target display resource is designated to meet a requirement of the advertisement delivery.

In some embodiments, the promotional performance evaluation metrics comprise a plurality of types;
performing intelligent bidding for the target product based on the estimated result includes:
determining a current growth stage level of the target product and establishing a growth objective based on the determined current growth stage level;
selecting one specific promotional performance evaluation metric from the plurality of
types of promotional performance evaluation metrics based on the growth objective, and performing intelligent bidding for the target product based on the estimated result for a selected promotional performance evaluation metric.

In some embodiments, the method further includes:
collecting statistical data on the actual promotional performance of the target product during their promotional display on the product recommendation page based on the intelligent bidding result;
determining an optimization adjustment to a region matching strategy, demographic matching strategy, and/or intelligent bidding strategy for the target product based on a statistical result.

An intelligent advertisement delivery method, including:
providing an intelligent delivery operation option on an interface configured for advertisement delivery setup for a target object;
upon receiving a delivery request from a first user through the intelligent delivery operation option, determining a set of products requiring intelligent advertisement delivery; during a process of responding to a product search request initiated by a second user or recommending a product to the second user, matching product information in the determined set of products with search key information or a region and/or demographic group associated with the second user; estimating promotional performance evaluation metrics for a target product; performing intelligent bidding for the target product based on an estimated result to determine, based on an intelligent bidding result, whether the target product qualifies for promotional display using a target display resource on a product recommendation page, wherein the target display resource is designated to meet a requirement of the advertisement delivery.

In some embodiments, the operation option includes an option for performing intelligent advertisement delivery for all products associated with the first user's store; upon receiving the first user's delivery request through the intelligent delivery operation option, all products in the store associated with the first user are determined to require intelligent advertisement delivery.

In some embodiments, the method further includes:
providing an operation option for budget setting, allowing the first user to specify budget information for an intelligent advertisement delivery process, wherein the intelligent bidding is also based on the budget information.

In some embodiments, the method further includes:
providing an intelligent delivery management interface during the process of promoting and displaying products on a product search result page based on the intelligent bidding result, wherein the management interface is configured to display real-time statistical information on the actual promotional performance of the target product.

A computer-readable storage medium storing a computer program, wherein the program, when executed by a processor, implements the steps of any of the aforementioned methods.

An electronic device, comprising:
one or more processors; and
a memory associated with the one or more processors, wherein the memory is configured to store program instructions, and the program instructions, when read and executed by the one or more processors, implement the steps of any of the aforementioned methods.

A computer program product comprising a computer program/computer-executable instructions, wherein the computer program/computer-executable instructions, when executed by a processor in an electronic device, implement the steps of any of the aforementioned methods.

According to the specific embodiments provided in this application, the following technical effects are disclosed:
through the embodiments of this application, first users such as merchants can initiate intelligent advertisement delivery requests and specify products that require intelligent advertisement delivery. Subsequently, there is no need for manual operations such as keyword binding or bidding. Instead, the system can, during the process of responding to product search requests initiated by second users such as consumers, match the product information in the product set with key information associated with the search request. Alternatively, during the process of recommending products to second users, the system can match the products in the product set with specific regions or demographics associated with the second user. For products with successfully matched key information or region/demographic data, and belonging to the product set as target products, the system can estimate the promotional performance evaluation metrics available for the target products. Subsequently, based on the estimation results, the system can perform intelligent bidding for the target products to determine whether the target products are eligible to obtain target display resources on search result pages or product recommendation pages for promotional display. This approach simplifies the advertisement delivery process for first users, helping them reduce operational costs and achieve better long-term business outcomes.

In a preferred embodiment, during intelligent bidding, different bidding strategies can be provided based on the growth stage level of various products and their corresponding growth objectives. For example, for new products, intelligent bidding can be primarily based on the click-through rate (CTR) metric; for potential products, it can be primarily based on the conversion rate metric; and for trending products, it can be primarily based on the transaction value metric. This approach helps facilitate the incubation of products at different growth stages, supporting their development and growth process.

Additionally, during the advertisement delivery process, real-time statistical analysis of actual delivery performance can be utilized to optimize and adjust key information matching strategies, intelligent bidding strategies, and other related aspects.

Implementing any product of this application does not necessarily require achieving all the aforementioned advantages simultaneously.

### BRIEF DESCRIPTION OF THE DRAWINGS

To provide a clearer explanation of the technical solutions in the embodiments of this application or in the prior art, a brief introduction to the drawings used in the embodiments is provided below. It is evident that the drawings described below are merely some examples of the embodiments of this application. For those skilled in the art, other drawings may be obtained based on these drawings without requiring inventive effort.

FIG. 1 is a schematic diagram of the system architecture provided by the embodiments of this application.

FIG. 2 is a flowchart of the first method provided by the embodiments of this application.

FIG. 3 is a schematic diagram of the interface provided by the embodiments of this application.

FIG. 4 is a flowchart of the second method provided by the embodiments of this application.

FIG. 5 is a flowchart of the third method provided by the embodiments of this application.

FIG. 6 is a schematic diagram of the electronic device provided by the embodiments of this application.

### DETAIL DESCRIPTION OF THE EMBODIMENTS

Below, the technical solutions in the embodiments of this application will be clearly and comprehensively described in conjunction with the accompanying drawings. It is evident that the described embodiments are merely a portion of the embodiments of this application, not all of them. All other embodiments obtained by those skilled in the art based on the embodiments disclosed in this application fall within the scope of protection of this application.

In the embodiments of this application, a solution related to intelligent advertisement delivery is provided. This solution is designed to enable e-commerce platform merchants to create promotional plans with a single click, without requiring specialized promotional knowledge or complex configurations. Merchants can initiate the delivery process without the need for keyword binding, regional or demographic premium configuration, and the like. In preferred embodiments, the system can automatically perform optimization and adjustments, eliminating the need for merchants to conduct tedious operational fine-tuning, thus achieving fully managed customer acquisition through advertising. This approach simplifies the traditionally complex multi-step creative process on e-commerce platforms into a single-step operation. Moreover, the plurality of steps typically required for daily advertisement optimization by merchants can be fully automated, reducing the effort to “zero” steps.

Specifically, an intelligent advertisement delivery operation entry point can be provided for users such as merchants and buyers (collectively referred to as “first users” in this application). After a merchant initiates intelligent delivery, a set of products requiring intelligent advertisement delivery can be identified. Subsequently, during product searches initiated by consumers or buyers (collectively referred to as “second users” in this application) or during the process of recommending products to second users, automatic matching can be performed for key information, regions, and/or demographics. In addition, the promotional performance evaluation metrics available for the target products can be estimated. Based on the estimation results, intelligent bidding can be performed for the target products. The intelligent bidding results can then determine whether the target products qualify for promotional display using target display resources on search result pages or product recommendation pages. For example, the target products can be ranked based on the intelligent bidding results, and the ranking can determine which specific products gain promotional opportunities. In practical implementations, the intelligent bidding results are influenced not only by the estimation results of the promotional performance evaluation metrics, but also by the budget configuration information of the first user. For instance, the proportion of the intelligent bid can be determined based on the estimation results of the promotional performance evaluation metrics and then multiplied by the first user's budget to obtain the actual intelligent bid value. Furthermore, during the matching process, the matched products may include both products with manual bids set by the first user and products with intelligent bids. In such cases, both types of products can be ranked together, and the final ranking determines which products gain promotional opportunities, among other possibilities.

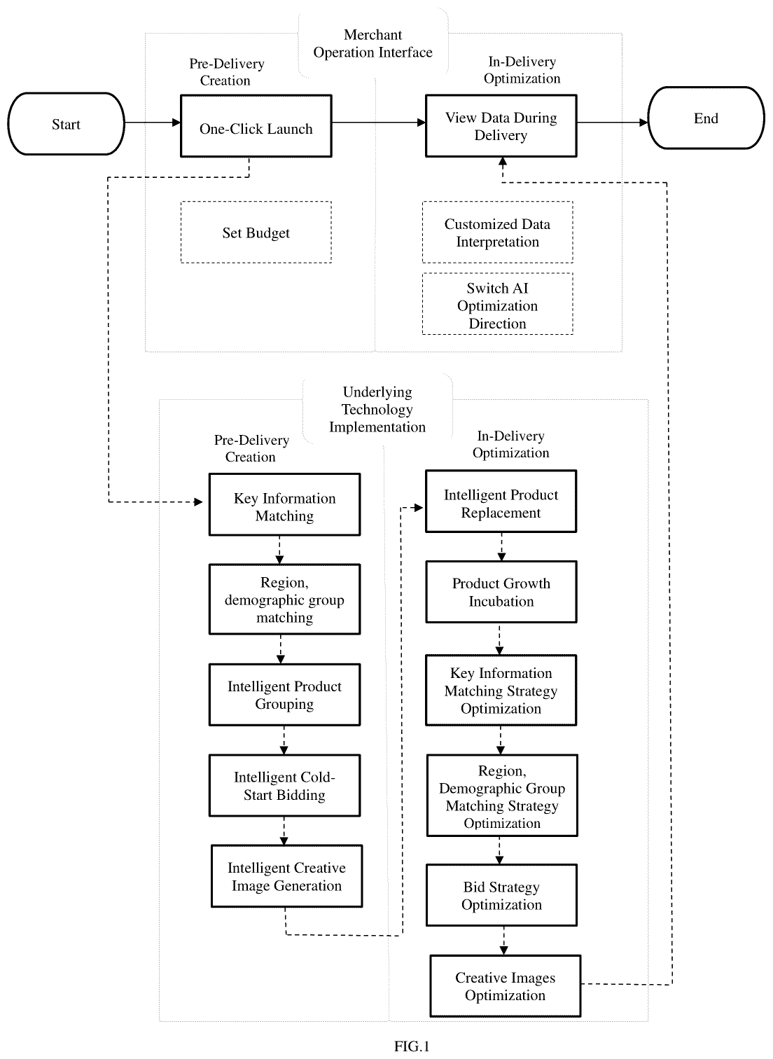

From a system architecture perspective, as shown in FIG. 1, the embodiments of this application provide a system for configuring advertisement delivery for first users, such as merchants. This system includes an operation interface that offers an intelligent delivery operation option. The first user can initiate intelligent delivery through this option and specify the products requiring intelligent delivery (e.g., by selecting “full-store intelligent delivery”). Additionally, the first user can configure a budget through this interface. Once the first user initiates intelligent delivery, the server can save the configuration information provided by the first user, and intelligent delivery can proceed for the specified products based on the aforementioned delivery strategies. The intelligent delivery process may include a “pre-delivery creation” phase (referred to as “pre-delivery creation” in FIG. 1) and, optionally, an “in-delivery optimization” phase (referred to as “in-delivery optimization” in FIG. 1). For the pre-delivery creation phase, the system can perform intelligent matching of the key information entered by the second user in search scenarios. In recommendation scenarios, it can perform targeted matching with the second user's region, demographics, and other attributes. The system can also estimate the promotional performance evaluation metrics available for the products. Subsequently, intelligent bidding can be conducted based on the estimation results. Since no data related to the specific delivery process is available at this stage, this bidding process can be referred to as a “cold-start” bidding. The intelligent bidding results then determine whether the target products qualify for promotional display using target display resources on search result pages. Optionally, during the intelligent bidding process, products can be grouped based on their growth stage levels (e.g., new products, potential products, trending products). Specific growth objectives can be set for each group, and intelligent bidding can be performed for each group by referencing the estimation results of different promotional performance evaluation metrics. Furthermore, AIGC (Artificial Intelligence Generated Content) technology can be utilized to generate creative images for products that qualify for promotional display. These creative images can be displayed in promotional resource slots to enhance promotional performance metrics, such as click-through rates.

Additionally, in a preferred embodiment, real-time optimization and adjustments can be performed during the delivery process, referred to as the “in-delivery optimization” phase in FIG. 1. During the optimization process, adjustments can be made based on the actual promotional performance of the products. These adjustments may include optimizing the key information matching strategy, regional and demographic matching strategies, and intelligent bidding strategies. For AIGC (Artificial Intelligence Generated Content) creative images, optimizations can also be implemented, such as replacing or refining the scenarios depicted in the creative images. The optimization process can further support the “incubation” of products at different growth stages. For example, a product initially classified as a new product may, through the intelligent delivery strategies provided in this application, achieve an increase in click-through rates, allowing it to transition into a potential product. Subsequently, the product would be subject to intelligent delivery strategies corresponding to its new classification as a potential product. This dynamic adjustment ensures that the delivery strategies evolve alongside the product's growth, continuously enhancing the effectiveness of the promotional efforts.

Below, the specific implementation schemes provided by the embodiments of this application are described in detail.

### Embodiment 1

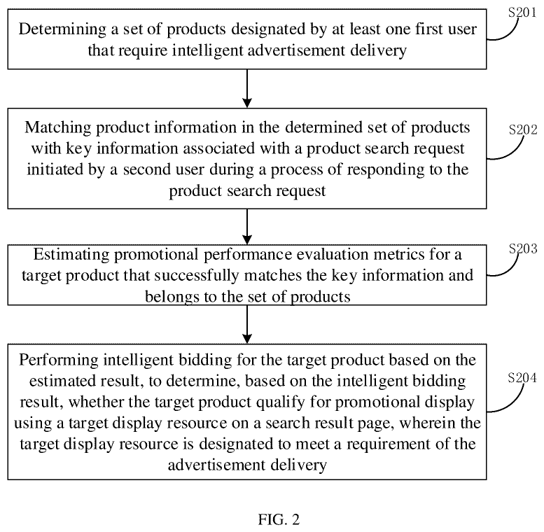

Firstly, Embodiment 1 introduces the intelligent delivery solution in search scenarios. Specifically, from the perspective of the server, Embodiment 1 provides a method for intelligent advertisement delivery. Referring to FIG. 2, this method may include the following steps:

S201: determining a set of products designated by at least one first user that require intelligent advertisement delivery.

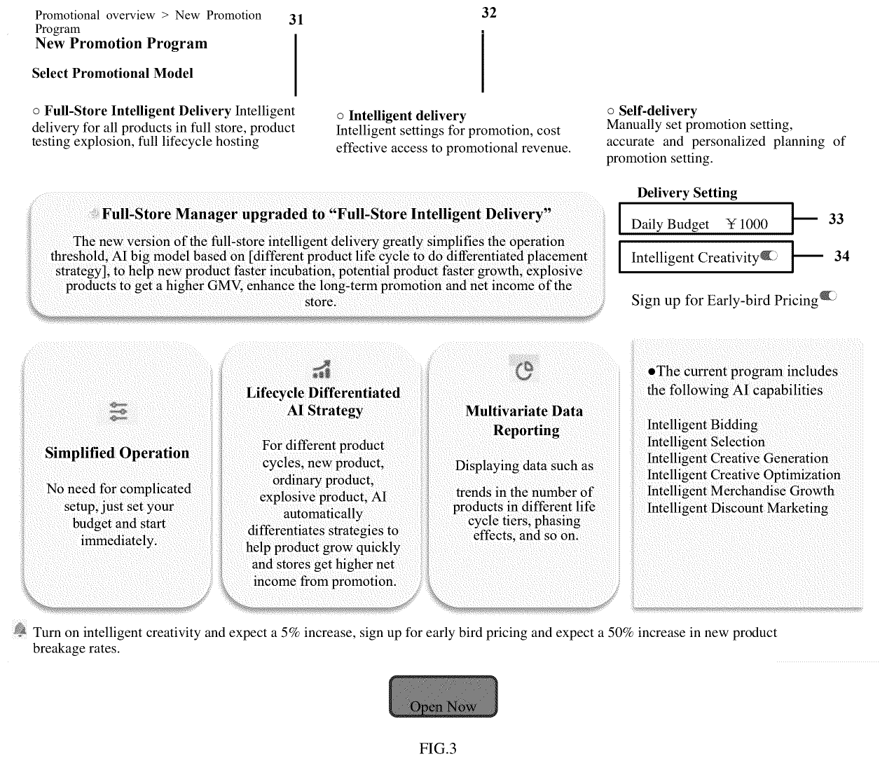

In practical implementation, the advertisement delivery system can provide an operation interface for the first user to create advertising plans, which includes an operation option for initiating intelligent delivery. The first user can use this option to submit a request for intelligent advertisement delivery. Additionally, the first user can specify a set of products requiring intelligent delivery. For instance, product IDs or other identifiers of the products requiring intelligent delivery can be submitted when the request is initiated. Alternatively, after submitting the request, a selectable product list can be provided, from which the first user can choose specific products for intelligent delivery. Considering that many first users may want to advertise all products within their store, a one-click intelligent delivery option for the entire store can also be provided. For example, as shown in FIG. 3, the “full-store intelligent delivery” option at 31 is designed for one-click intelligent delivery of all store products. Users can directly initiate an intelligent delivery request through this option. Alternatively, users can initiate a request via the “intelligent delivery” option at 32, and subsequently select specific products from a product list for intelligent delivery, among other possibilities.

It should be noted that in practical implementations, the budget information for intelligent delivery can be configured by the first user. For example, as shown at 33 in FIG. 3, the “daily budget” configuration option allows the first user to set a daily budget. Of course, the budget configuration cycle is not limited to daily settings; it can also be configured on a weekly, bi-weekly, or monthly basis, among other options. Additionally, as mentioned earlier, for products that qualify for promotion, creative images can be generated using AIGC technology for display in promotional resource slots. The first user can choose whether to enable this feature. For example, the first user can use the “intelligent creativity” toggle option shown at 34 in FIG. 3 to decide whether to use this functionality.

S202: matching product information in the determined set of products with key information associated with a product search request initiated by a second user during a process of responding to the product search request.

After identifying the products designated by the first user for intelligent advertisement delivery, it is not necessary to perform explicit keyword binding, demographic binding, or similar operations in the embodiments of this application. Instead, real-time matching of key information or region and demographic data can be performed during the process of a second user conducting a search or receiving product recommendations. This embodiment focuses on the search scenario. Specifically, after the second user initiates a search by entering key information, the system can match the products with the provided key information.

The key information can specifically include keywords and, in scenarios such as “image search,” may also include key images, among others. When matching the product information in the product set with the key information associated with the product search request, the process can involve extracting attributes such as the product title, properties, and textual/visual details and matching them with the key information entered by the second user. This matching process can directly check whether the product title, textual details, and other content contain the specified key information or synonymous and semantically similar information. Alternatively, since the key information may include both keywords and key images, and product information may include text, images, or other formats, the matching may involve multi-modal information on both sides. To enhance the accuracy and efficiency of the matching process, AI large models capable of processing multi-modal information can be utilized to perform the matching between product information and the key information in the search request. This enables more robust and precise results.

S203: estimating promotional performance evaluation metrics for a target product that successfully matches the key information and belongs to the set of products.

After completing the key information matching, if a product is successfully matched with the current key information and belongs to the set of products requiring intelligent advertisement delivery, the promotional performance evaluation metrics for the target product can be estimated. Since there are typically a plurality of target products meeting these criteria, the promotional performance evaluation metrics can be estimated individually for each target product.

The specific promotional performance evaluation metrics may include a plurality of types, such as click-through rate (CTR), conversion rate, and transaction value, among others. CTR refers to the probability of a product being clicked by users if it is displayed in an advertisement resource slot on the search result page corresponding to the current search process. Conversion rate refers to the probability of a product being clicked by users and subsequently converted into a purchase if it is displayed in an advertisement resource slot on the search result page corresponding to the current search process. Transaction value refers to the total monetary value obtained from a product after it is displayed in an advertisement resource slot on the search result page, clicked by users, and converted into purchases. For the transaction value metric, it is often associated with a plurality of SKUs of the same product, wherein each SKU corresponds to different price attributes. In such cases, when different second users purchase the product and select different SKUs, the prices vary, which directly impacts the transaction value of the product.

S204: performing intelligent bidding for the target product based on an estimated result, to determine, based on an intelligent bidding result, whether the target product qualifies for promotional display using a target display resource on a search result page, wherein the target display resource is designated to meet a requirement of the advertisement delivery.

After estimating the promotional performance evaluation metrics for a plurality of target products, intelligent bidding can be performed for these target products based on the estimation results. In other words, in the embodiments of this application, intelligent bidding for products can be carried out according to the estimated values of the promotional performance evaluation metrics. Specific bidding strategies can vary; for instance, the higher the estimated value of the promotional performance evaluation metric, the higher the bid value may be, among other strategies.

When performing intelligent bidding, the budget set by the first user can also be taken into account. Specifically, when conducting intelligent bidding based on the estimated results of promotional performance evaluation metrics and the first user's configured budget, the BCB (Budget Constrained Bidding) algorithm can be applied. The BCB algorithm models the optimization problem for global traffic and maximizes overall output under budget constraints provided by the first user, thereby guiding the bidding strategy. For example, under this algorithm, the estimated results of the promotional performance evaluation metrics determine the bid proportion rather than directly setting the bid value. As a result, even if two products have very high estimated click-through rates during a particular search, their actual intelligent bid values may differ depending on the budgets configured by their respective first users, among other factors.

Additionally, in the embodiments of this application, products can be grouped based on their growth stage levels, and different groups can adopt tailored intelligent bidding strategies. The growth stage level of a product generally refers to its information quality score, which is typically determined by the system based on the product's sales performance. The score range into which a product falls determines its specific growth stage level. For example, specific growth stage levels may include:
new product: refers to products that have just been listed or were recently listed, typically with minimal or no sales records or reviews;
potential product: refers to products with sales potential or those that are underdeveloped. These products may belong to emerging categories or reflect changes in market demand. Generally, if a product is performing normally without errors but does not exhibit exceptional results, the system will typically assign it to this level;
trending product refers to products that are highly successful in terms of sales volume and popularity or have created a strong impact among consumers. These products typically stand out due to their unique or distinctive features or their ability to meet specific customer needs to obtain exceptional sales performance. For merchants, turning their products into trending products is a common goal, as it can generate more inquiries and orders, significantly benefiting their business.

Generally, a product may undergo a growth process transitioning from a new product to a potential product and finally to a trending product. Although not all products have the opportunity to become trending products, merchants typically hope their products exhibit such a growth trajectory. In this context, the growth objectives and approaches for products at different stages can vary. For instance, for new products, the growth objective is typically to become potential products, and the approach is to increase the click-through rate (CTR); for potential products, the growth objective is to transition into trending products, and the approach is to enhance the conversion rate; for trending products, as the conversion rate is already high, the focus usually shifts to achieving higher transaction value. This could involve converting SKUs with higher price attributes, among other strategies. It is evident that the growth paths for products at these different stages involve metrics such as CTR, conversion rate, and transaction value, which are also key promotional performance evaluation metrics. Therefore, in the embodiments of this application, product growth can be integrated with the promotional performance evaluation metrics used during the intelligent delivery process. By combining these aspects, more targeted intelligent bidding strategies can be implemented for products at different growth stages.

In other words, the specific promotional performance evaluation metrics include a plurality of types, such as the aforementioned click-through rate (CTR), conversion rate, and transaction value. When performing intelligent bidding, the growth stage level of the target product can first be determined. Based on this growth stage level, the growth objective of the target product can be established. Subsequently, one specific promotional performance evaluation metric can be selected according to the growth objective, and intelligent bidding can be performed for the target product based on the estimated result of that metric. For the same target product, the estimated values for metrics like CTR, conversion rate, and transaction value may vary. For example, a product might have a high estimated CTR, an average conversion rate, and a low transaction value. In this case, when performing intelligent bidding based on these estimated values, the system can prioritize the metric that aligns with the product's current growth stage and use the corresponding estimated result as the basis for intelligent bidding.

Specifically, if a target product is currently in the new product stage, its growth objective can be determined as transitioning into a potential product by improving its click-through rate (CTR). In other words, for new products, CTR is the primary metric that needs to be enhanced. Therefore, intelligent bidding for the target product can be based on its estimated CTR results. If a new product has a relatively high estimated CTR, even if its estimated results for other metrics, such as conversion rate or transaction value are not high, the product can still be assigned a relatively high intelligent bid based on its CTR performance.

If the current growth stage is the potential product stage, the growth objective for the target product can be determined as transitioning into a trending product by improving its conversion rate. Intelligent bidding for the target product can then be based on its estimated conversion rate results. A trending product is defined as a product with a conversion rate exceeding a specific threshold. Here, the conversion rate refers to the rate calculated from the historical sales records of the same product, rather than the estimated conversion rate mentioned earlier.

Additionally, if a target product is currently in the trending product stage, where its conversion rate exceeds the specified threshold, the growth objective for the product can be determined as increasing its transaction value. In this case, intelligent bidding for the target product can be based on its estimated transaction value results.

After completing intelligent bidding for a plurality of target products, the products can be ranked based on the bidding results. If the products matching the current search key information also include products with manual bids set by the first user, these can be included in the ranking process as well. The final ranking determines which products qualify for display in the designated promotional resource slots on the search result page. These resource slots may include preset promotional positions on the search result page, such as the first resource slot (commonly referred to as the “top slot”), among others.

Additionally, in the embodiments of this application, apart from intelligent bidding, once specific target products qualify for promotion, a creative image can be generated for the target product using an image generation model. This creative image serves as the representative image for the target product and is displayed in the corresponding promotional resource slot. The image generation model can specifically be a large-scale parameter model based on AIGC (Artificial Intelligence Generated Content), also known as an AI large model. AI large models are machine learning models with large-scale parameters and complex computational structures, often constructed using deep neural networks with billions or even trillions of parameters. These models are designed to enhance expressive capabilities and predictive performance, enabling them to handle more complex tasks and data. AI large models simulate human intelligence, cognitive processes, and behavior through computational modeling, thus enabling intelligent actions. They provide both an explanation of and a means to emulate human intelligence, supporting the development of more advanced AI systems. Currently, AI large models have demonstrated mature capabilities in tasks such as text and image generation. Leveraging the image generation capabilities of AI large models, this application can create creative images for products that qualify for promotion. For example, a scene image can be generated by adding an appropriate background to the original plain white background image. This scene image can then be used as the representative image of the product and displayed in the promotional resource slot. Such enhancements can further improve promotional performance metrics like click-through rates.

The above discussion introduced intelligent bidding during the intelligent advertisement delivery process provided in this application's embodiments, a phase that can be referred to as a “cold start.” Additionally, to achieve better promotional performance, real-time optimization of intelligent delivery strategies can be implemented. Specifically, during the promotion and display of products on the search result page based on the intelligent bidding results, the actual promotional performance of the target products can be collected and analyzed. For instance, statistics on metrics such as actual clicks, conversions, and transaction value can be gathered. If these metrics fail to meet the expected promotional outcomes, subsequent optimization adjustments can be made when new second users submit search requests. These adjustments may include modifications to the key information matching strategy or the bidding strategy during intelligent bidding. For example, suppose that when a second user searches for a specific keyword A, a product X qualifies for promotion. However, upon analyzing the statistics, the actual click-through rate for product X is found to be unsatisfactory. In such a case, the keyword matching strategy can be adjusted to reduce the matching weight of product X with keyword A, thereby decreasing its chances of being promoted in search scenarios involving keyword A. This allows product X to be promoted in search scenarios associated with other keywords instead, enhancing overall performance.

Additionally, in scenarios requiring the generation of creative images for a target product, a plurality of optional scenes may be available for creative image generation. However, since only one scene is typically required for actual display, a specific scene can be arbitrarily selected during the cold-start phase for generating the creative image. Subsequently, during the delivery process, in addition to optimizing the key information matching strategy and bidding strategy, the creative image generation strategy can also be optimized based on metrics such as the product's actual click-through rate. For instance, suppose that during the cold-start phase, a creative image related to Scene 1 was used for a product, but statistical analysis later reveals that the product's click-through rate is unsatisfactory. In such a case, other scene-related creative images can be generated and used when promoting the product in future campaigns.

It should be noted that during the process of optimizing delivery strategies, the incubation of product growth stages can also be achieved. In such cases, the delivery strategy for a product can be adjusted accordingly. For example, if a product initially classified as a new product experiences rapid growth in click-through rates due to the intelligent delivery strategies provided in this application's embodiments, it may successfully transition into a potential product. Once this transition occurs, the intelligent delivery strategy for the product will be adjusted to align with that of potential products. This means that the intelligent bidding strategy, previously focused on improving click-through rates, will shift to a strategy aimed at enhancing conversion rates, among other potential adjustments.

In summary, through the embodiments of this application, first users, such as merchants, can initiate intelligent advertisement delivery requests and designate specific products requiring intelligent delivery. Subsequently, there is no need for manual operations such as keyword binding or bidding. Instead, the system automatically matches the product information in the designated product set with the key information associated with search requests initiated by second users, such as consumers. For products with successfully matched key information that belong to the product set, the system estimates the promotional performance evaluation metrics available for these target products. Based on the estimation results, intelligent bidding is performed to determine whether the target products qualify for promotional display using the target display resources on the search result page. This approach simplifies the advertisement delivery process for first users, helping them reduce operational costs and achieve better long-term business outcomes.

In a preferred embodiment, intelligent bidding can incorporate different strategies based on the growth stage level of the products and their corresponding growth objectives. For example: for new products, intelligent bidding can primarily focus on the click-through rate (CTR) metric; for potential products, it can prioritize the conversion rate metric; for trending products, it can focus on the transaction value metric, among others. This approach facilitates the incubation and development of products at various growth stages, supporting their growth process and helping them achieve their full potential.

Additionally, during the delivery process, real-time statistics on the actual performance of the advertisement can be used to optimize and adjust strategies such as key information matching and intelligent bidding.

### Embodiment 2

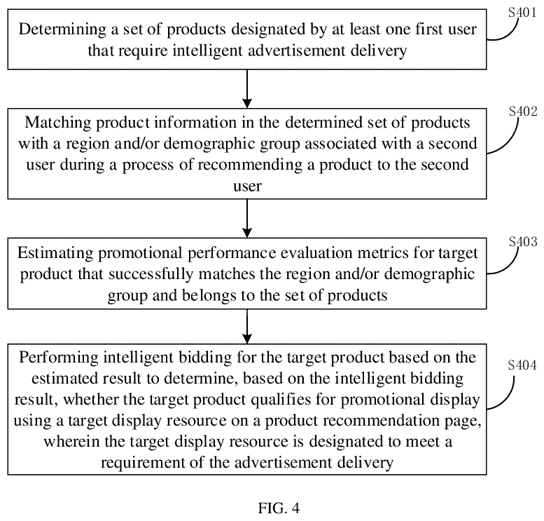

Embodiment 2 focuses on advertisement delivery in product recommendation scenarios. From the perspective of the server, a method for intelligent advertisement delivery is provided. Referring to FIG. 4, the method may include the following steps:
S401: determining a set of products designated by at least one first user that require intelligent advertisement delivery;
S402: during the process of recommending products to a second user, match the product information in the product set with the region and/or demographic group associated with the second user;
S403: for products with successful region and/or demographic matches that belong to the product set, estimate the promotional performance evaluation metrics available for the target products;
S404: performing intelligent bidding for the target products based on the estimated results to determine, based on the bidding results, whether the target products qualify for promotional display using target display resources on the product recommendation page; wherein the target display resources are designated to meet the advertisement delivery requirements.

In Embodiment 2, products can also be grouped according to their growth stage levels, with distinct intelligent bidding strategies provided for each group. For example, the current growth stage level of the target product can be determined, and based on this level, the growth objective for the target product can be established. Subsequently, one specific promotional performance evaluation metric can be selected according to the growth objective. Intelligent bidding for the target product can then be conducted based on the estimated result of this selected metric.

Additionally, during the process of promoting and displaying products on the product recommendation page based on the intelligent bidding results, the actual promotional performance of the target products can be collected and analyzed. Based on these statistical results, adjustments can be made to the region and/or demographic matching strategy and/or the intelligent bidding strategy corresponding to the target products.

Furthermore, in Embodiment 2, creative images can also be generated for products that qualify for promotion. These images can be used as product visuals in advertisement resource slots, effectively enhancing click-through rates and boosting overall promotional performance.

### Embodiment 3

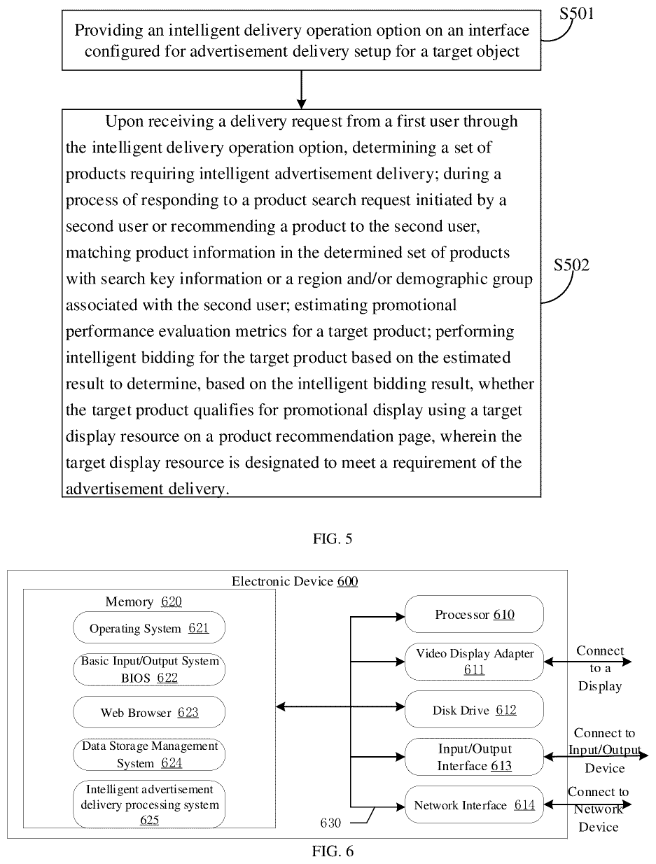

Embodiment 3 corresponds to Embodiments 1 and 2, providing a method for intelligent advertisement delivery from the perspective of the first user's client. Referring to FIG. 5, the method may include the following steps:
S501: providing an intelligent delivery operation option on an interface configured for advertisement delivery setup for a target object;
S502: matching product information in the determined set of products with a region and/or demographic group associated with a second user during a process of recommending a product to the second user; estimating promotional performance evaluation metrics for target product that successfully match the region and/or demographic group and belong to the set of products; performing intelligent bidding for the target product based on an estimated result to determine, based on an intelligent bidding result, whether the target product qualifies for promotional display using a target display resource on a product recommendation page, wherein the target display resource is designated to meet a requirement of the advertisement delivery.

During specific implementation, the operation option may include an option for performing intelligent advertisement delivery for all products associated with the first user's store. Upon receiving the first user's delivery request through this operation option, all products in the store associated with the first user are determined to require intelligent advertisement delivery.

Additionally, an operation option for budget setting can be provided, allowing the first user to specify budget information for the intelligent advertisement delivery process. The intelligent bidding process will also take this budget information into account.

During the process of promoting and displaying products on the product search result page based on intelligent bidding results, an intelligent delivery management interface can be provided. This management interface is used to display real-time statistical information on the actual promotional performance of the target products.

For the parts not detailed in Embodiments 2 and 3, reference can be made to the descriptions in Embodiment 1 and other sections of this specification, which will not be repeated here.

It should be noted that the embodiments of this application may involve the use of user data. In practical applications, user-specific personal data can be used within the scope permitted by applicable laws and regulations, provided that the requirements of such laws are met (e.g., obtaining explicit user consent, providing clear user notification, etc.).

Corresponding to Embodiment 1, this application also provides a device for intelligent advertisement delivery. The device may include the following components:
product set determination unit: used to determine a product set designated by at least one first user that requires intelligent advertisement delivery;
product matching unit: used during the process of responding to a product search request initiated by a second user, and matches the product information in the product set with the key information associated with the product search request;
estimation unit: used to estimate the promotional performance evaluation metrics available for target products that successfully match the key information and belong to the product set;
intelligent bidding unit: used to perform intelligent bidding for the target products based on the estimation results, and determines whether the target products qualify for promotional display using the target display resources on the search result page; these target display resources are specifically allocated to meet the advertisement delivery requirements.

The promotional performance evaluation metrics are of a plurality of types;
the intelligent bidding unit can specifically perform the following:
determining the current growth stage level of the target product and, based on this level, establish the growth objective for the target product;
performing the determination of one specific promotional performance evaluation metric from the plurality of available types based on the growth objective, and performing intelligent bidding for the target product based on the estimated result of the selected metric.

Specifically, the promotional performance evaluation metrics include the click-through rate (CTR) metric;
the intelligent bidding unit can specifically perform the following:
if the current growth stage is the new product stage, determining the growth objective of the target product as transitioning into a potential product by improving its CTR. This enables intelligent bidding for the target product based on its estimated results for the CTR metric.

Alternatively, the promotional performance evaluation metrics may include the conversion rate metric;
the intelligent bidding unit can specifically perform the following:
if the current growth stage is the potential product stage, determining the growth objective of the target product as transitioning into a trending product by improving its conversion rate. Intelligent bidding for the target product can then be performed based on its estimated results for the conversion rate metric; a trending product is defined as a product with a conversion rate exceeding a specified threshold.

Alternatively, the promotional performance evaluation metrics may include the transaction value metric;
the intelligent bidding unit can specifically perform the following:
if the current growth stage is the trending product stage where the conversion rate exceeds the threshold, determining the growth objective of the target product as increasing its transaction value. Intelligent bidding for the target product can then be performed based on its estimated results for the transaction value metric.

Additionally, the device can also include:
budget information retrieval unit: used to retrieve budget information configured by the first user for intelligent advertisement delivery needs;
the intelligent bidding unit can specifically perform the following:
conducting intelligent bidding for the target product based on the estimated results and the budget information.

Furthermore, the device can also include:
creative image generation unit: used to generate a creative image for the target product using an image generation model after determining that the product has qualified for promotion in the target display resource on the search result page; this creative image is used as the representative image for the target product and displayed in the corresponding target display resource slot.

Additionally, the device can also include:
statistical unit: used to collect and analyze the actual promotional performance of target products during their promotion and display on the product search result page based on intelligent bidding results;
optimization adjustment unit: used to determine and implement optimizations or adjustments to the key information matching strategy and/or the intelligent bidding strategy for the target products based on the statistical results.

Corresponding to embodiment two, this application also provides a device for intelligent advertisement delivery. The device may include the following components:
product set determination unit: used to determine a set of products designated by at least one first user that require intelligent advertisement delivery;
user matching unit: used during the process of recommending products to a second user to match the product information in the product set with the region and/or demographic group associated with the second user;
estimation unit: used to estimate the promotional performance evaluation metrics available for target products that successfully match the region and/or demographic group and belong to the product set;
intelligent bidding unit: used to perform intelligent bidding for the target products based on the estimation results. This determines whether the target products qualify for promotional display using the target display resources on the product recommendation page. These target display resources are allocated to meet the advertisement delivery requirements.

The promotional performance evaluation metrics include a plurality of types.

The intelligent bidding unit can specifically perform the following:
determining the current growth stage level of the target product and, based on this level, establishing the growth objective for the target product;
based on the growth objective, determining one specific promotional performance evaluation metric from the plurality of available metrics, and performing intelligent bidding for the target product based on its estimated results for the selected metric.

Additionally, the device can also include:
statistical unit: used to collect and analyze the actual promotional performance of target products during their promotion and display on the product recommendation page based on intelligent bidding results;
optimization and adjustment unit: used to determine and implement optimizations or adjustments to the region, demographic matching strategy, and/or intelligent bidding strategy for the target products based on the statistical results.

Corresponding to Embodiment 3, this application also provides a device for intelligent advertisement delivery. The device may include the following components:
operation option provision unit: used to provide an intelligent delivery operation option on an interface configured for advertisement delivery setup for a target object;
product set determination unit: used to determine a set of products requiring intelligent advertisement delivery after receiving the first user's delivery request through the intelligent delivery operation option; match the product information in the product set with search key information or the region and/or demographic group associated with the second user during the process of responding to a product search request initiated by the second user or recommending products to the second user; estimate the promotional performance evaluation metrics available for the target products; perform intelligent bidding for the target products based on the estimation results; the bidding results determine whether the target products qualify for promotional display using the target display resources on the product recommendation page; these target display resources are specifically allocated to meet the advertisement delivery requirements.

The operation option includes an option for performing intelligent advertisement delivery for all products associated with the first user's store. Upon receiving the first user's delivery request through this operation option, all products in the store associated with the first user are determined to require intelligent advertisement delivery.

Additionally, the device can also include:
budget setting option provision unit: used to provide an operation option for budget setting, allowing the first user to specify budget information for the intelligent advertisement delivery process. The intelligent bidding process is also influenced by this budget information.

Furthermore, the device can also include:
management interface display unit: used to provide an intelligent delivery management interface during the process of promoting and displaying products on the product search result page based on intelligent bidding results; this management interface displays real-time statistical information on the actual promotional performance of the target products.

Additionally, this application embodiment also provides a computer-readable storage medium on which a computer program is stored. When executed by a processor, this program implements the steps of any of the methods described in the aforementioned embodiments.

Furthermore, an electronic device is provided, comprising:
one or more processors; and
a memory associated with the one or more processors, wherein the memory is configured to store program instructions. When the program instructions are read and executed by the one or more processors, they perform the steps of any of the methods described in the aforementioned embodiments.

A computer program product is provided, comprising computer programs or computer-executable instructions. When executed by the processor in an electronic device, these programs or instructions implement the steps of the methods described in the aforementioned embodiments.

FIG. 6 exemplarily illustrates the architecture of an electronic device, which specifically includes a processor 610, a video display adapter 611, a disk drive 612, input/output interfaces 613, a network interface 614, and memory 620. These components, including the processor 610, video display adapter 611, disk drive 612, input/output interfaces 613, and network interface 614, communicate with the memory 620 via a communication bus 630.

The processor 610 can be implemented using a general-purpose CPU (Central Processing Unit), a microprocessor, an Application Specific Integrated Circuit (ASIC), or one or more integrated circuits. It is used to execute relevant programs to implement the technical solutions provided by this application.

The memory 620 can be implemented in the form of ROM (Read Only Memory), RAM (Random Access Memory), static storage devices, dynamic storage devices, etc. The memory 620 can store the operating system 621 used to control the operation of the electronic device 600, and the Basic Input/Output System (BIOS) 622 used to control low-level operations of the electronic device 600. Additionally, it can store the web browser 623, the data storage management system 624, and the intelligent advertisement delivery processing system 625, among others. The intelligent advertisement delivery processing system 625 is an application that specifically implements the aforementioned operational steps in the embodiments of this application. In conclusion, when the technical solutions provided in this application are implemented through software or firmware, the relevant program code is stored in the memory 620 and executed by the processor 610.

The input/output interface 613 is used to connect input/output modules to enable information input and output. The input/output module can be configured as a component within the device (not shown in the figure) or externally connected to the device to provide corresponding functions. The input devices may include a keyboard, mouse, touchscreen, microphone, and various types of sensors. The output devices may include a display, speakers, vibrator, and indicator lights, among others.

The network interface 614 is used to connect to a communication module (not shown in the figure) to enable communication and interaction between this device and other devices. The communication module can facilitate communication either through wired means (e.g., USB, Ethernet cables) or wireless methods (e.g., mobile networks, Wi-Fi, Bluetooth).

The bus 630 serves as a pathway for transmitting information between the various components of the device, such as the processor 610, video display adapter 611, disk drive 612, input/output interface 613, network interface 614, and memory 620.

It should be noted that although the device described above only illustrates components such as the processor 610, video display adapter 611, disk drive 612, input/output interface 613, network interface 614, memory 620, and bus 630, in practical implementation, the device may also include other components necessary for normal operation. Additionally, those skilled in the art will understand that the device may include only the components necessary to implement the solutions of this application and does not need to contain all the components shown in the figure.

From the description of the above embodiments, it can be understood by those skilled in the art that this application can be implemented by combining software with a necessary general hardware platform. Based on this understanding, the technical solutions of this application, essentially or in terms of the contributions made to the prior art, can be embodied in the form of a software product. This computer software product can be stored in a storage medium, such as ROM, RAM, magnetic disks, optical disks, etc., and includes several instructions for enabling a computer device (e.g., a personal computer, server, or network device) to execute the methods described in various embodiments or parts of embodiments of this application.

The various embodiments in this specification are described in a progressive manner, with similar or identical parts across embodiments cross-referenced. Each embodiment focuses on highlighting differences from other embodiments. In particular, for systems or system embodiments, since they are fundamentally similar to method embodiments, their descriptions are relatively concise, with relevant details referring to the descriptions of method embodiments. The systems and system embodiments described above are merely illustrative. The units described as separate components may or may not be physically separated, and the components displayed as units may or may not be physical units. They can either be located in one place or distributed across a plurality of network units. Parts or all of the modules can be selected based on actual needs to achieve the objectives of the embodiment. Those skilled in the art can understand and implement the embodiments without inventive effort.

The method and electronic device for intelligent advertisement delivery provided by this application have been described in detail above. Specific examples have been used in this document to explain the principles and implementations of this application. The descriptions of the above embodiments are intended only to facilitate understanding of the methods and core concepts of this application. Meanwhile, general technical personnel in the field may make variations to the specific implementations and application scope based on the ideas of this application. In conclusion, the content of this specification should not be construed as limiting this application.

What is claimed is:

1. An intelligent advertisement delivery method, comprising:
determining a set of products designated by at least one first user that require intelligent advertisement delivery;
matching product information in the determined set of products with key information associated with a product search request initiated by a second user during a process of responding to the product search request;
estimating promotional performance evaluation metrics for a target product that successfully matches the key information and belongs to the set of products;
performing intelligent bidding for the target product based on the estimated result, to determine, based on the intelligent bidding result, whether the target product qualifies for promotional display using a target display resource on a search result page, wherein the target display resource is designated to meet a requirement of the advertisement delivery.

2. The method of claim 1, wherein:
the promotional performance evaluation metrics comprise a plurality of types;
performing intelligent bidding for the target product based on the estimated result comprises:
determining a current growth stage level of the target product and establishing a growth objective based on the determined current growth stage level;
selecting one specific promotional performance evaluation metric from the plurality of types of promotional performance evaluation metrics based on the growth objective, and performing intelligent bidding for the target product based on the estimated result for the selected promotional performance evaluation metric.

3. The method of claim 2, wherein:
the promotional performance evaluation metrics include a click-through rate (CTR) metric;
determining the growth objective of the target product based on the current growth stage level comprises:
if the current growth stage level is a new product stage, determining the growth objective of the target product as transitioning into a potential product by improving the CTR, wherein intelligent bidding is performed for the target product based on the estimated result for the CTR metric.

4. The method of claim 2, wherein:
the promotional performance evaluation metrics include a conversion rate metric;
determining the growth objective of the target product based on the current growth stage level comprises:
if the current growth stage level is a potential product stage, determining the growth objective of the target product as transitioning into a trending product by improving the conversion rate, wherein intelligent bidding is performed for the target product based on the estimated result for the conversion rate metric; the trending product is defined as a product with a conversion rate exceeding a specified threshold.

5. The method of claim 2, wherein:
the promotional performance evaluation metrics include a transaction value metric;
determining the growth objective of the target product based on the current growth stage level comprises:
if the current growth stage level is a trending product stage where a conversion rate exceeds a specified threshold, determining the growth objective of the target product as increasing the transaction value, wherein intelligent bidding is performed for the target product based on the estimated result for the transaction value metric.

6. The method of claim 1, further comprising:
obtaining budget information configured by the first user for the intelligent advertisement delivery requirements;
performing intelligent bidding for the target product based on the estimated result comprises:
performing intelligent bidding for the target product based on the estimated result and the budget information.

7. The method of claim 1, further comprising:
upon determining that a target product has qualified for promotional display using a target display resource on the search result page, generating a creative target image for the target product using an image generation model, wherein the creative target image is used as a representative image of the target product and displayed in the corresponding target display resource.

8. The method of claim 1, further comprising:
collecting statistical data on the actual promotional performance of the target product during its promotional display on the search result page based on the intelligent bidding result;
determining an optimization adjustment to a key information matching strategy and/or an intelligent bidding strategy for the target product based on a statistical result.

9. A non-transitory computer-readable storage medium configured with instructions executable by one or more processors to cause the one or more processors to perform the method of claim 1.

10. An electronic device comprising:
one or more processors; and
one or more computer-readable memories coupled to the one or more processors and having instructions stored thereon that are executable by the one or more processors to perform the method of claim 1.

11. An intelligent advertisement delivery method, comprising:
determining a set of products designated by at least one first user that require intelligent advertisement delivery;
matching product information in the determined set of products with a region and/or demographic group associated with a second user during a process of recommending a product to the second user;
estimating promotional performance evaluation metrics for target product that successfully matches the region and/or demographic group and belongs to the set of products;
performing intelligent bidding for the target product based on the estimated result to determine, based on the intelligent bidding result, whether the target product qualifies for promotional display using a target display resource on a product recommendation page, wherein the target display resource is designated to meet a requirement of the advertisement delivery.

12. The method of claim 11, wherein:
the promotional performance evaluation metrics comprise a plurality of types;
performing intelligent bidding for the target product based on the estimated result comprises:
determining a current growth stage level of the target product and establishing a growth objective based on the determined current growth stage level;
selecting one specific promotional performance evaluation metric from the plurality of types of promotional performance evaluation metrics based on the growth objective, and performing intelligent bidding for the target product based on the estimated result for the selected promotional performance evaluation metric.

13. The method of claim 11, further comprising:
collecting statistical data on the actual promotional performance of the target product during their promotional display on the product recommendation page based on the intelligent bidding result;
determining an optimization adjustment to a region matching strategy, demographic matching strategy, and/or intelligent bidding strategy for the target product based on a statistical result.

14. A non-transitory computer-readable storage medium configured with instructions executable by one or more processors to cause the one or more processors to perform the method of claim 11.

15. An electronic device comprising:
one or more processors; and
one or more computer-readable memories coupled to the one or more processors and having instructions stored thereon that are executable by the one or more processors to perform the method of claim 11.

16. An intelligent advertisement delivery method, comprising:
providing an intelligent delivery operation option on an interface configured for advertisement delivery setup for a target object;
upon receiving a delivery request from a first user through the intelligent delivery operation option, determining a set of products requiring intelligent advertisement delivery;
during a process of responding to a product search request initiated by a second user or recommending a product to the second user, matching product information in the determined set of products with search key information or a region and/or demographic group associated with the second user;
estimating promotional performance evaluation metrics for a target product;
performing intelligent bidding for the target product based on the estimated result to determine, based on an intelligent bidding result, whether the target product qualifies for promotional display using a target display resource on a product recommendation page, wherein the target display resource is designated to meet a requirement of the advertisement delivery.

17. The method of claim 16, wherein:
the operation option includes an option for performing intelligent advertisement delivery for all products associated with the first user's store;
upon receiving the first user's delivery request through the intelligent delivery operation option, all products in the store associated with the first user are determined to require intelligent advertisement delivery.

18. The method of claim 16, further comprising:
providing an operation option for budget setting, allowing the first user to specify budget information for an intelligent advertisement delivery process, wherein the intelligent bidding is also based on the budget information.

19. The method of claim 16, further comprising:
providing an intelligent delivery management interface during the process of promoting and displaying products on a product search result page based on the intelligent bidding result, wherein the management interface is configured to display real-time statistical information on the actual promotional performance of the target product.

20. An electronic device comprising:
one or more processors; and
one or more computer-readable memories coupled to the one or more processors and having instructions stored thereon that are executable by the one or more processors to perform the method of claim 16.
